(19) United States
(12) Patent Application Publication
(10) Pub. No.: US 2026/0366600 A1
(43) Pub. Date: Nov. 19, 2026

(54) LINEAR DRIVE ASSEMBLY

(71) Applicant: Kerr Machine Co., Sulphur, OK (US)

(72) Inventors: Kelcy Jake Foster, Sulphur, OK (US); Micheal Cole Thomas, Azle, TX (US); Christopher Todd Barnett, Ada, OK (US); Nicholas Son, Roff, OK (US); John Keith, Duncan, OK (US)

(21) Appl. No.: 19/753,757

(22) Filed: Jul. 24, 2026

Related U.S. Application Data
(63) Continuation of application No. 19/200,031, filed on May 6, 2025, now Pat. No. 12,692,929.
Application No. 19/200,031 is a continuation of application No. 18/765,766, filed on Jul. 8, 2024, now Pat. No. 12,320,409.
(60) Provisional application No. 63/513,501, filed on Jul. 13, 2023.

(51) Int. Cl. F16H 21/28; F04B 53/14; F16C 5/00; F16C 33/10; F16H 57/01; F16H 57/04

(52) U.S. Cl. CPC F16H 21/28; F04B 53/146; F16C 5/00; F16C 33/1055; F16C 33/1065; F16C 33/108; F16H 57/01; F16H 57/042

(57) ABSTRACT

A pair of wear grooves for a linear drive assembly. One wear groove is disposed on a wear plate attached to a crosshead. This wear groove is on a front edge of the wear plate, and does not intersect any lubrication groove. Another wear groove is disposed circumferentially about an inner wall of a crosshead guide. Each of the wear grooves is observable to an operator without fully disassembling the crosshead and the crosshead guide, and each is observable from a single side of the crosshead guide. Should the wear groove not be observable, the associated component should be replaced. Should the wear groove be observable, the remaining life of the component can be determined from the groove’s depth.

### SUMMARY

The present invention is directed to a linear drive assembly. The linear drive assembly comprises a crosshead and a pair of wear plates. The crosshead is configured to be installed within a crosshead guide and comprises upper and lower surfaces. The pair of wear plates are removably attached to a corresponding one of the upper and lower surface of the crosshead. Each wear plate has an outer surface and a front edge. Each plate has at least one lubricant groove and at least one plate wear groove. The at least one lubricant groove is formed in the outer surface of the wear plate and is in fluid communication with lubricant ports formed in the crosshead. The at least one plate wear groove is formed in the outer surface of the wear plate and is distinct from the at least one lubricant groove. The at least one wear plate groove is not in fluid communication with any lubricant port formed in the crosshead. The at least one wear plate groove opens on the front edge of the wear plate.

In another aspect, the invention is directed to a kit. The kit comprises a crosshead guide, a linear drive assembly, and a first wear plate. The crosshead guide has a longitudinal bore formed therein. The linear drive assembly is configured to be installed within the longitudinal bore of the crosshead guide. The linear drive assembly comprises upper and lower surfaces and defines a lubricant channel in the upper surface and the lower surface.

The first wear plate is configured for removable attachment to the upper surface of the linear drive assembly. The first wear plate is defined by an inner surface conforming to the upper surface of the linear drive assembly, an outer surface, and a front edge. At least one lubricant groove is formed within the outer surface of the first wear plate. A lubricant port interconnects the inner surface to the outer surface and intersects the at least one lubricant groove. The at least one wear groove is formed in the outer surface of the first wear plate and is distinct from the at least one lubricant groove.

### BRIEF DESCRIPTION OF THE DRAWINGS

FIG. 1 is a front perspective view of one embodiment of a high-pressure pump.

FIG. 2 is a front perspective view of the power end assembly shown in FIG. 1.

FIG. 3 is an enlarged view of area A, shown in FIG. 2.

FIG. 4 is an enlarged view of area B, shown in FIG. 3.

FIG. 5 is a front perspective view of one embodiment of a linear drive assembly disclosed herein.

FIG. 6 is a front perspective view of the linear drive assembly shown in FIG. 5 with the wear plate and wear plate fasteners shown exploded from the assembly.

FIG. 7 is a top perspective view of one of the wear plates shown in FIG. 6.

FIG. 8 is an enlarged view of area C, shown in FIG. 7.

FIG. 9 is a front perspective view of one of the crosshead guides used within the power end assembly shown in FIG. 2.

FIG. 10 is a cross-sectional view of the crosshead guide shown in FIG. 9, taken along line D-D.

FIG. 11 is an enlarged view of area E, shown in FIG. 10.

### DETAILED DESCRIPTION

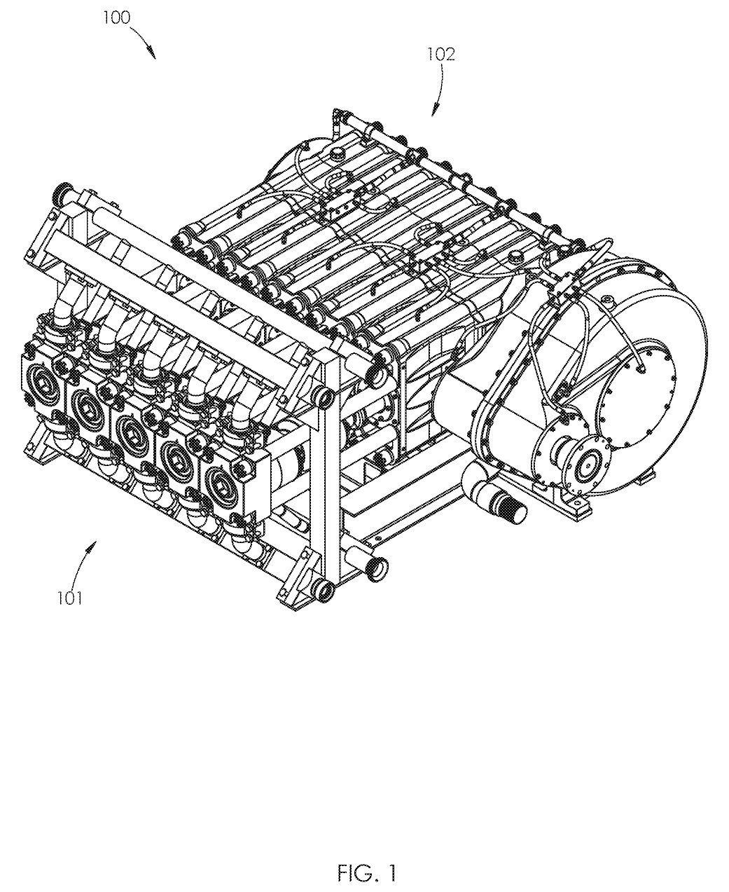

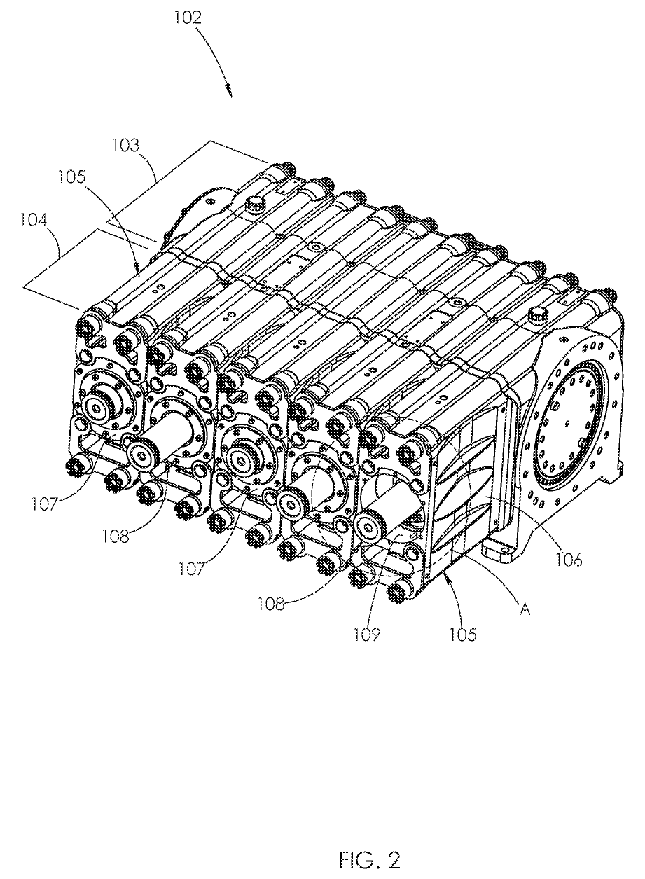

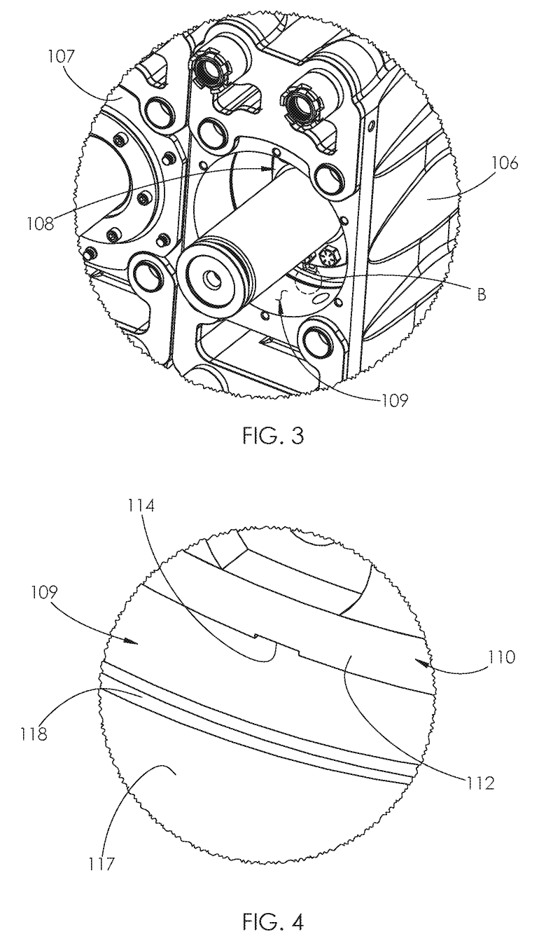

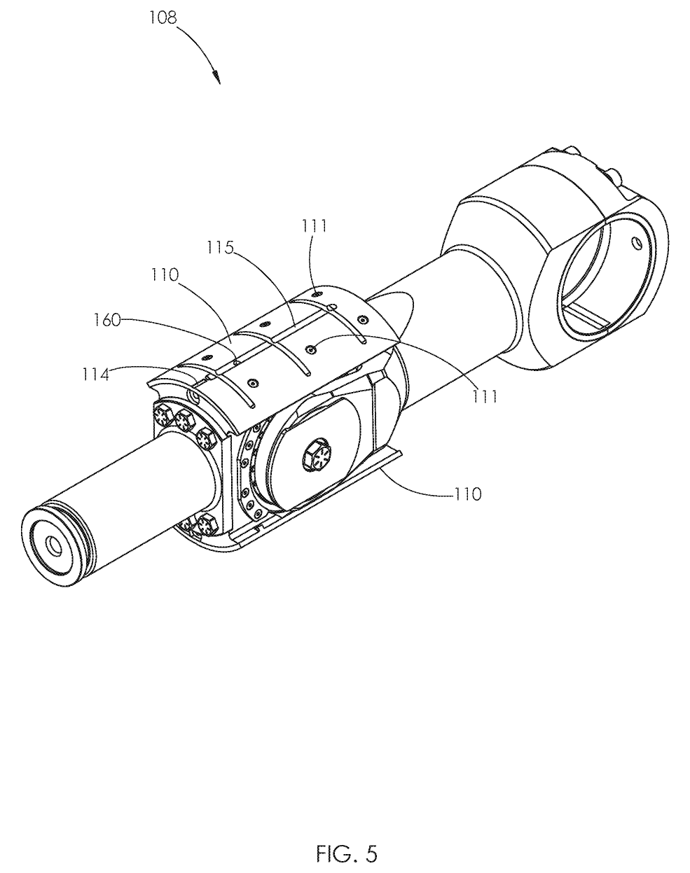

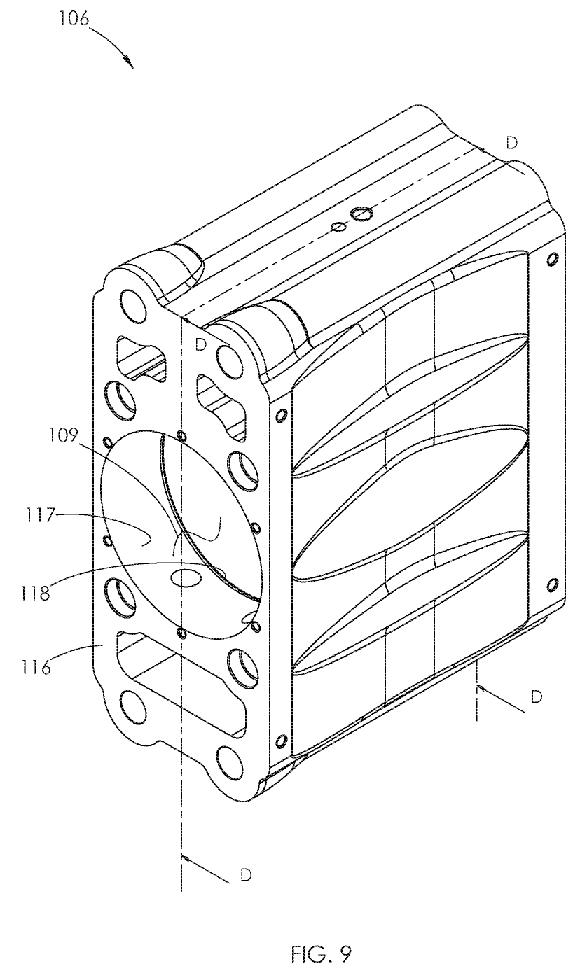

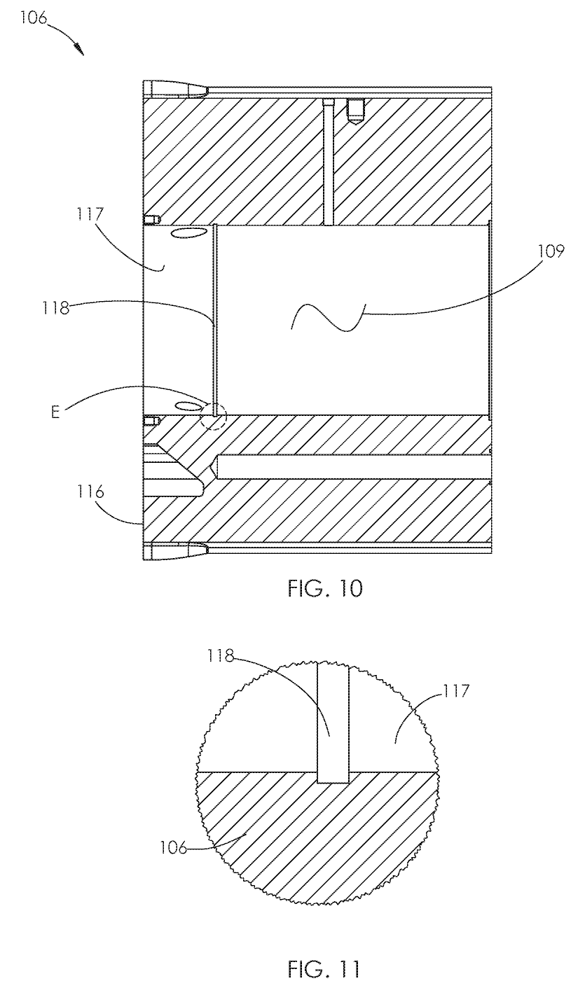

Turning now to FIGS. 1-11, one embodiment of a high-pressure pump 100 is shown. The high-pressure pump 100 comprises a fluid end assembly 101 attached to a power end assembly 102 as shown in FIG. 1. The power end assembly 102, shown in FIG. 2, comprises a crank section 103 joined to a crosshead section 104. Continuing with FIG. 2, the crosshead section 104 comprises a plurality of crosshead guide assemblies 105 situated in a side-by-side relationship. Each crosshead guide assembly 105 comprises a crosshead guide 106, a pony rod cover 107, and a linear drive assembly 108. A crosshead bore 109 is formed within each crosshead guide 106, as shown in FIGS. 9-10, and each crosshead bore 109 is sized to receive a portion of a linear drive assembly 108 which includes a crosshead, as shown in FIGS. 2-3. Continuing with FIGS. 5-8, the linear drive assembly 108 comprises a plurality of wear plates 110 and a plurality of wear plate fasteners 111.

One such high-pressure pump 100 is disclosed in U.S. Pat. No. 11,953,000, issued to Foster et al., the entire contents of which are incorporated herein by reference.

Each crosshead bore 109 and linear drive assembly 108 are configured to allow the operator to easily determine the amount of wear on the crosshead bore 109 and wear plates 110. Knowing the amount of wear on the crosshead bore 109 and/or the wear plates 110 eliminates the need to further disassemble the power end assembly 102 during maintenance to measure the amount of wear on the components thus saving time.

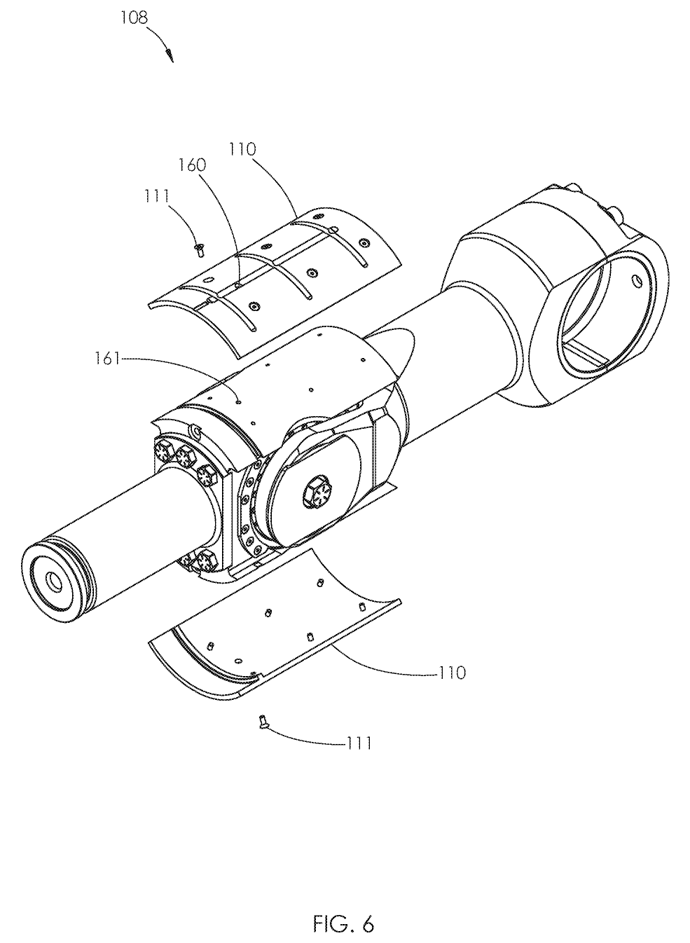

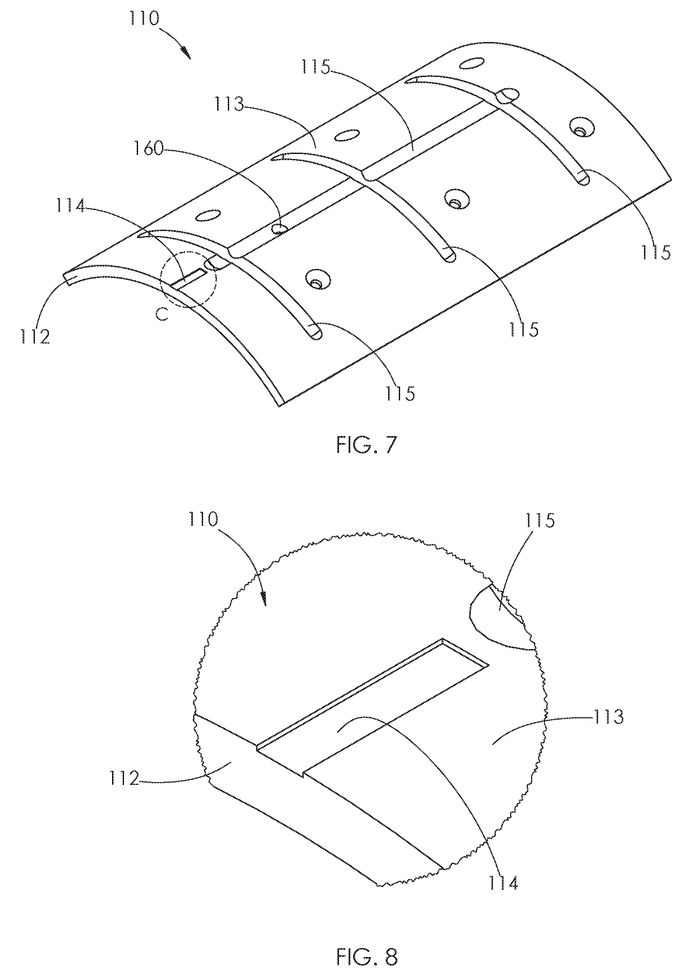

Referring now to FIGS. 7-8, a wear plate 110 is shown. The wear plate 110 comprises a front surface 112 and an outer surface 113. The outer surface 113 comprises a wear indicator groove 114 and a plurality of lubrication channels 115. The lubrication channels 115 are formed in the outer surface 113 and have a lubrication port 160 disposed through the wear plate 110. The lubrication port 160 is in fluid communication with a lubrication passage 161 (FIG. 6) formed in the crosshead of the linear drive assembly 108. In this way, lubricant may be distributed from within the linear drive assembly 108 to the lubrication channel 115 of each wear plate 110. As shown, the lubrication channel 115 comprises a longitudinal passage and intersecting radial passages. Thus, the intersecting radial passage may be characterized as “substantially perpendicular” to the longitudinal passage, as it extends substantially at a ninety degree angle relative to the longitudinal passage on the wear plate 110. However, the wear plate 110 may have a curvature, along which the radial path extends.

The wear indicator groove 114 is separate and distinct from the lubrication channels 115. Specifically, the wear indicator groove 114 is not in fluid communication with the lubrication channels 115. The wear indicator groove 114 intersects the front surface 112 so that when the wear plate 110 is viewed from the front the wear indicator groove 114 appears as a notch in the outside radius of the front surface 112, which can be seen in FIG. 4. As shown in this embodiment, the wear indicator groove 114 is located approximately centered on the circumference of the outer surface 113. However, the wear indicator groove 114 may be located anywhere along the circumference of the outer surface 113. Also, the wear indicator groove 114 is shown extending longitudinally perpendicular to the front surface 112. The longitudinal distance is only constrained by the necessity to not intersect any lubrication channel 115. Additionally, the only restriction on circumferential width of the wear indicator groove 114 is that it must be less than the total circumferential length of the outer surface 113 allowing for a visual comparison to determine wear on the wear plate 110. The depth of the wear indicator groove 114 is 0.050 to 0.075 inches but may be larger or smaller.

Referring now to FIGS. 9-11, a crosshead guide 106 is shown. The crosshead guide 106 comprises a front surface 116 and a crosshead bore 109. The crosshead bore 109 comprises a bore wall 117 and a wear indicator groove 118. The wear indicator groove 118 is formed around the entire circumference of the bore wall 117. The longitudinal position of the wear indicator groove 118 is anywhere between the front surface 116 of the crosshead guide 106 and the location of the front surface 112 of the wear plate 110 when the linear drive assembly 108 is fully retracted. The depth of the wear indicator groove 118 is 0.050 to 0.075 inches but may be larger or smaller.

The wear indicator groove 118 of the crosshead bore 109 may be formed in only a portion of the circumference of the bore wall 117 or there may be a plurality of wear indicator grooves 118 formed in portions of the circumference of the bore wall 117. If a plurality of partially circumferential wear indicator grooves 118 is used they may be spaced longitudinally. There may also be a plurality of fully circumferential wear indicator grooves 118 formed in the bore wall 117 which would be longitudinally spaced. It is also contemplated that one or more wear indicator grooves 118 may be formed in the bore wall 117 parallel to, or at an angle to, the longitudinal axis.

Referring now to FIGS. 2-4, during maintenance operations in which the pony rod cover 107 is removed the operator may visually determine the amount of wear on both the crosshead bore 109 and the wear plates 110. To determine the amount of wear on the wear plates 110 the operator observes the wear indicator groove 114 as shown in FIG. 4. If the wear indicator groove 114 is still observable then the wear plate 110 still has usable life and need not be replaced. If no wear indicator groove 114 can be seen, the wear plate 110 should be replaced or the linear drive assembly 108 flipped. Since it is expected that the operator knows the depth of the wear indicator groove 114 in a new wear plate 110 the depth of the observed wear indicator groove 114 will provide the operator an indication of the approximate remaining life of the wear plate 110. For instance, if the operator observes the depth of the wear indicator groove 114 to be approximately half that of a new one after fifty hours of operation, the operator can assume that the wear plate 110 will provide another fifty hours of operational life and re-check the wear plates 110 at that time.

Continuing with FIGS. 2-4, the amount of wear on the crosshead bore 109 may be determined by operator observation when the pony rod cover 107 is removed. If the operator can still see the wear indicator groove 118 in the crosshead bore 109 then the crosshead guide 106 need not be replaced. As with the wear plate 110 an estimate of remaining life may be made by comparing the observed depth of the wear indicator groove 118 to that of a new one and assuming a linear, or other known, rate of wear.

The various features and alternative details of construction of the apparatuses described herein for the practice of the present technology will readily occur to the skilled artisan in view of the foregoing discussion. It is to be understood that even though numerous characteristics and advantages of various embodiments of the present technology have been set forth in the foregoing description, together with details of the structure and function of various embodiments of the technology, this detailed description is illustrative only, and changes may be made in detail. Changes may especially be made in matters of structure and arrangements of parts within the principles of the present technology to the full extent indicated by the broad general meaning of the terms in which the appended claims are expressed.

1. A method for measuring wear within a power end assembly of a high-pressure fracturing pump, the method comprising:
installing a wear plate on an outer surface of a crosshead to form a linear drive assembly, wherein the wear plate comprises a wear indicator groove formed therein; and
installing the linear drive assembly at least partially within a crosshead guide so that the wear indicator groove is visible.

2. The method of claim 1, further comprising:
observing the wear indicator groove when the linear drive assembly is at least partially installed within the crosshead guide.

3. The method of claim 1, wherein the crosshead guide comprises an inner bore having a walled surface defining a second wear indicator groove therein; wherein the second wear indicator groove is visible when the linear drive assembly is at least partially installed within the crosshead guide.

4. The method of claim 1, wherein the crosshead guide is attached to a crankshaft frame via a plurality off stay rods.

5. The method of claim 1, further comprising:
without removing the linear drive assembly from the crosshead guide, observing the wear plate’s wear indicator groove; and
if the wear indicator groove is not observable, replacing the wear plate.

6. The method of claim 5, further comprising:
if the wear indicator groove is observable, measuring a depth of the wear indicator groove; and
estimating a remaining life of the wear plate based upon the measured depth of the wear indicator groove.

7. An apparatus, comprising:
a power end assembly, comprising:
a crank frame;
a crosshead guide connected to the crank frame;
a crosshead situated at least partially within the crosshead guide; and
a wear indicator plate attached to the crosshead, the wear indicator plate comprising a wear indicator groove formed therein along an exterior edge of the wear indicator plate;
in which the wear indicator groove is visible when the crosshead is at least partially situated within the crosshead guide.

8. The apparatus of claim 7, in which the crosshead guide comprises:
a bore formed therein;
a wall surrounding the bore; and
a second wear indicator groove formed in the wall;
in which the second wear indicator groove is visible when the crosshead is situated at least partially within the crosshead guide.

9. The apparatus of claim 8, in which the second wear indicator groove is formed about an entire circumference of the wall.

10. The apparatus of claim 8, in which the second wear indicator groove has a depth of between 0.050 inches and 0.075 inches.

11. The apparatus of claim 7, in which the wear indicator plate further comprises a lubrication groove; in which the wear indicator groove is not in fluid communication with the lubrication groove.

12. The apparatus of claim 7, in which the power end assembly further comprises a plurality of wear plate fasteners; in which the wear indicator plate is attached to the crosshead via the plurality of wear plate fasteners.

13. A method of using the apparatus of claim 7, the method comprising:
installing the wear indicator plate on an outer surface of the crosshead to form a linear drive assembly; and
installing the linear drive assembly at least partially within the crosshead guide so that the wear indicator groove is visible.

14. The method of claim 13, further comprising:
without removing the linear drive assembly from the crosshead guide, observing the wear indicator plate’s wear indicator groove; and
if the wear indicator groove is not observable, replacing the wear indicator plate.

15. The method of claim 14, further comprising:
if the wear indicator groove is observable, measuring a depth of the wear indicator groove; and thereafter
estimating a remaining life of the wear indicator plate based upon the measured depth of the wear indicator groove.

16. An apparatus, comprising:
a power end assembly, comprising:
a crosshead guide, comprising:
a bore formed therein, the bore defining a plurality of first wear indicator grooves formed therein;
a crosshead installed at least partially within the crosshead guide; and
a wear plate attached to the crosshead, the wear plate comprising:
a second wear indicator groove; and
a lubricant groove;
in which the wear indicator groove and the lubricant groove are not in fluid communication with one another;
in which the plurality of first wear indicator grooves are visible when the crosshead is installed at least partially within the crosshead guide; and
in which the second wear indicator groove is visible when the crosshead is installed at least partially within the crosshead guide.

17. A method of using the apparatus of claim 16, comprising:
without removing the crosshead from the crosshead guide, observing the second wear indicator groove of the wear plate; and
if the second wear indicator groove is not observable, flipping the crosshead and attached wear plate such that the wear plate engages a different portion of the bore.

18. A method of using the apparatus of claim 16, comprising:
observing the plurality of first wear indicator grooves while the crosshead is at least partially installed within the crosshead guide; and
determining a remaining life of the crosshead guide based upon the amount of visible first wear indicator grooves observed.

19. The apparatus of claim 16, in which the wear plate is attached to the crosshead via a plurality of fasteners.

20. The apparatus of claim 16, in which each of the plurality of first wear indicator grooves is circumferential.
